(19) United States
(12) Patent Application Publication
(10) Pub. No.: US 2008/0117754 A1
(43) Pub. Date: May 22, 2008

(54) Calibration method for Optimum Power Control (OPC) of laser write strategy in an optical storage device

(76) Inventor: CHIH-CHING YU, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 11/561,420

(22) Filed: Nov. 20, 2006

(51) Int. Cl. G11B 7/12

(52) U.S. Cl. 369/47.53

(57) ABSTRACT

A calibration method for Optimum Power Control (OPC) of laser power in an optical storage device comprises selecting a plurality of first sections on an optical disc; applying a first laser write strategy to each of the first sections; reading a first feature value from each of the first sections to thereby obtain a plurality of first feature values; calculating a sub value according to the first feature values; and calibrating the laser write strategy according to the sub value.

### BACKGROUND OF THE INVENTION

1. Field of the Invention

The present invention relates to optical disc recording, in particular, a calibration method for Optimum Power Control (OPC) of laser write strategy in an optical storage device.

2. Description of the Prior Art

Since its inception into the market, optical media discs have provided an affordable and convenient way to store and transport dense amounts of digital data. The popularity of these discs have drastically driven the once high costs associated with them down to its currently affordable price point, in order to meet market equilibrium. One of the distinct advantages offered by optical storage discs, is their ability to reliably record (and possibly re-record) data such that they can be re-read multiple times while maintaining a high data integrity, partially attributed to the digital nature in which the data is stored. Of the several types of optical media now available, many popular choices include CDs, CD-Rs, DVDs, DVD-Rs, and BlueRay discs.

Generally, optical discs are made of an optical stack, comprising a polycarbonate substrate base, a photosensitive dye layer, an alloy reflector, and a protective lacquer overcoat. Some discs may also include an additional protective layer, depending on the manufacturer, although its inclusion does not affect operation of the disc.

In order to store information on the disc, data is written through an optical storage device by focusing a high power laser beam onto the photosensitive dye layer to create a spiral track of data marks. The marks include pits (low reflective areas) and lands (high reflective areas between the marks). The resulting pattern of pits and lands represent the digital information recorded onto the disc. This information can then be retrieved afterwards through optical disc readers, by now focusing a low-power laser beam onto the track marks and deciphering the reflected light beam collected at a photo-light detector.

Because precise lengths and depths of recorded marks are critical for accurate data representation, a procedure called Optimum Power Control (OPC) is typically used to calibrate laser power recording levels for recording data on the optical disc. However, manufacturers may use dye layers of various thicknesses, and different photoelectric properties according to the manufacturing material, or to compensate for various writing speeds. Therefore, the proper amount of laser power needed to record onto an optical disc varies from disc to disc, and may also depend on the recorder used and desired recording speed. If the laser power is found too high, oversized pits or marks may be created which may interfere with adjacent marks when read. If the laser power is too low, undersized marks may occur and possibly result in read errors or even failures.

The OPC procedure therefore calibrates the recording laser power of the optical storage device according to the recommended optimum recording estimate value (for example, a target Beta value indicating a target symmetrical measure) provided from the optical disc. A predetermined recording power setting (for example, power level or write strategy) is used as a starting point for writing test information in a special reserved area of the disc called the Power Calibration Area (PCA), where a series of various recording power settings around the predetermined setting are applied, and subsequently read. Differences (asymmetry or beta) between the read power values of pits and lands are typically converted to a beta value, which used to determine if the recording power is underpowered or overpowered. A negative beta value means that, on average, the recording marks are underpowered (short), while a positive beta means the marks are overpowered (long). Knowing these results, the optical storage device can now compensate for a negative beta value by appropriately increasing the recording power, and decrease the recording power for a positive beta value. In this way, the recording power can be optimized for a particular recording speed, optical disc and recorder combination.

Although the OPC procedure does adjust recording power levels for specific discs based on manufacturer recommended levels, it does not account for possible irregularities in the optical disc, which may have occur during manufacturing. For example, the reflectivity of certain discs may vary according to different regions of the disc. FIGS. 1 and 2 illustrate examples of discs having variable reflectivity across their surfaces. In FIG. 1, the left hand side of the optical disc appears to have a higher reflectivity than the right hand side of the disc. This phenomenon is known as wobble, and may be attributed to non-uniformities in the polycarbonate base, the photosensitive dye layer, or alloy reflector during manufacturing. Additionally, if the surface of the disc is warped, bent or contains dust, reflectivity on the surface may also differ. FIG. 2 shows another example, where the non-uniformities are not symmetrical, and the reflectivity changes according to a localized region of the disc.

Therefore, if the OPC is performed in a high reflectivity area, the recording power used to record on the entire disc may be too low, as the same high reflectivity will be assumed for the entire disc. Conversely, if the OPC is performed in a low reflectivity area, the recording power used for the whole disc may be too high. In either case, an under-optimized disc recording power level may result, as the final recording power does not take into consideration an average reflectivity of the entire optical disc.

### SUMMARY OF THE INVENTION

The present invention therefore attempts to solve the above mention problem, by providing a calibration method for Optimum Power Control (OPC) of laser power in an optical disc drive that considers a variance in reflectivity across the entire optical disc.

According to an embodiment of the present invention, a calibration method for Optimum Power Control (OPC) of laser write strategy in an optical storage device is provided. The method comprises: selecting a plurality of first sections on an optical disc; applying a first laser write strategy to each of the first sections; reading a first feature value from each of the first sections to thereby obtain a plurality of first feature values; calculating a sub value according to the first feature values; and calibrating the laser power according to the sub value. The laser write strategy may comprise a laser power level, or a write pulse shape setting.

According to another embodiment of the present invention, a calibration method for Optimum Power Control (OPC) of laser write strategy in an optical storage device is also provided. The method comprises: selecting a plurality of sections on an optical disc; selecting a plurality of laser write strategies, each laser write strategy being different; applying each of the laser write strategies to at least two different sections; reading a feature value from each of the sections to thereby obtain a plurality of feature values; calculating a sub value according to the feature values; and calibrating the laser write strategy according to the sub value.

According to an additional embodiment of the present invention, an optical storage device for performing Optimum Power Control (OPC) calibration is provided. The optical storage device comprises: a controller for selecting a plurality of first sections on an optical disc; an optical pickup coupled to the controller for applying a first laser write strategy to each of the first sections; and a feature value detector coupled to the optical pickup and the controller, for detecting a first feature value read from the optical pickup for each of the first sections to thereby obtain a plurality of first feature values; wherein the controller is further for calculating a sub value according to the first feature values and for calibrating laser write strategy of the optical pickup according to the sub value.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an optical disc having symmetrical, non-uniform reflectivity.

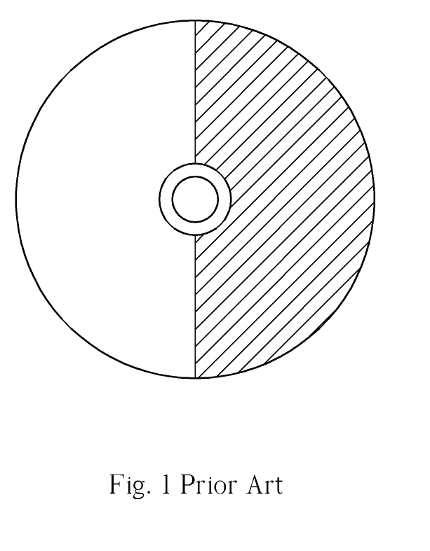

FIG. 2 is an optical disc having a non-symmetrical, non-uniform reflectivity.

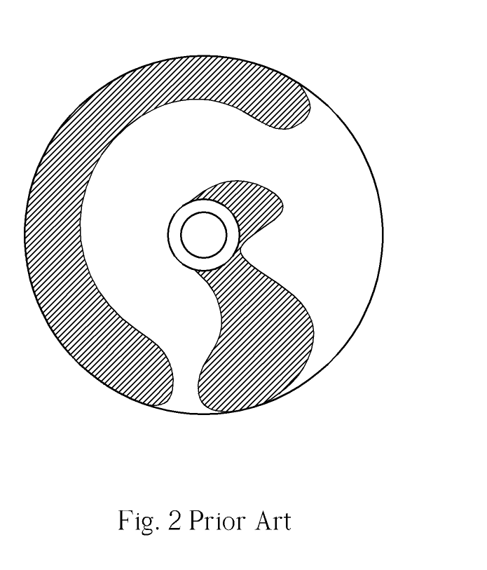

FIG. 3 illustrates selection of first and second sections on an optical disc 300 according to an embodiment of the present invention.

FIG. 4 further illustrates the selection of first and second sections on an optical disc 400 according to another embodiment of the present invention.

FIG. 5 is an embodiment illustrating the selection of a plurality of sections on an optical disc 500, as part of the calibration method of the present invention.

FIG. 6 is a graphical example detailing the calibration method of an embodiment of the present invention performed on an optical disc 600.

FIG. 7 is another graphical example detailing the calibration method of an embodiment of the present invention performed on an optical disc 700.

FIG. 8 is an embodiment of an optical storage device for performing OPC calibration according to the present invention.

FIG. 9 is a process flow chart illustrating the OPC calibration method according to an embodiment of the present invention.

FIG. 10 is another process flow chart illustrating the OPC calibration method according to another embodiment of the present invention.

### DETAILED DESCRIPTION

As optical discs are subject to design and manufacturing irregularities, as described above, simply performing an OPC procedure within the localized region of the PCA may not provide an optimized recording power level for the entire optical disc. This is because the PCA may be confined to a localized region, which may have different reflectivity characteristics than other regions. This invention therefore solves the problem by considering multiple sections of the disc when performing an OPC calibration procedure. In this way, an average reflectivity of the entire disc is considered in order to deduce a more accurate recording power level or write pulse shape applicable for the entire disc.

As described in the prior art, the typical OPC procedure consists of applying a range of test recording power levels in the PCA area, where each individual power level is applied only once to a single section before it is characterized. The present invention, however, applies each individual laser write strategies to a plurality of sections. The laser write strategies can correspond to laser recording powers, or laser recording pulse shapes. Therefore, multiple readings can be attained for each individual laser write strategy applied, allowing for an average reading of the entire disc to compensate for disc irregularities and inconsistencies in reflectivity.

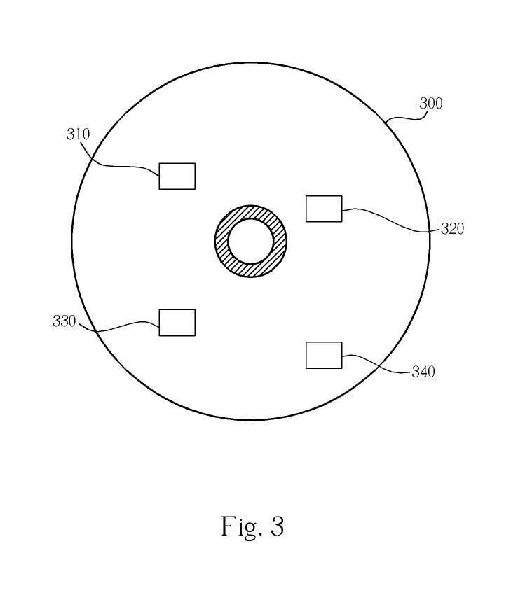

FIG. 3 is used to provide an abstract illustration for the OPC calibration method according to an embodiment of the present invention. An optical disc 300 is provided, where a plurality of first sections (310, 320 for example) are selected from it. Although only two first sections are shown in this example, please note that other embodiments may comprise of additional sections. Once selected, a first laser write strategy is applied to each of the first sections 310, 320. A first feature value is then extracted from each of the first sections to obtain a plurality of first feature values. A sub value can be calculated according to the first feature values, and subsequently used to determine optimal calibration of laser write strategy of the optical recording device.

In the present invention, the first feature value can represent any quantitative characteristic derived from the first sections after applying the first laser write strategy. In one embodiment, it is a beta value, while in other embodiments, it can be an RF peak to peak value, a length deviation value, an edge deviation value, or a bit error rate value. For example, length deviation is described in U.S. patent application Ser. No. 10/906,397, while edge deviation is described in the U.S. patent application Ser. No. 10/908,580. As these characteristics are generally known to those familiar to the related art, further explanation is omitted for brevity. The laser write strategy, on the other hand, can comprise a laser recording pulse shape or a laser recording power.

The specific choice of the first feature value type can be arbitrary, and can be selected in accordance to a desired characteristic by the user. Meanwhile, the sub value can be a statistical average (mean, deviation, etc.) of the first feature values, or a predetermined formula used to calculate or weigh the first feature values. The result of the sub value can then be compared to expected results to determine if calibration of laser write strategy is necessary for the optical recording device.

To ensure the location of the first sections prior to application of the laser write strategy, the method can employ the use of relevant signals in the verification of the position of the optical pickup emitting the laser write strategy relative to the correct optical disc position. One embodiment utilizes a hall (FG) signal, which can be obtained from a hall detector. The hall signal is produced according to the hall effect resulting from a magnetic spindle motor used to rotate the optical disc. The hall signal therefore provides an indication of movement of the disc, which can be interpreted to provide a relative position of the critical entities within a range of precision. Alternatively, an address signal, which can be provided by an optical pickup when reading the optical disc, can be used to verify the locations of the first sections prior to write strategy application.

In another embodiment of the present invention method, a second laser recording power can be additionally used with the embodiment illustrated above. Also referring to FIG. 3, a plurality of second sections (330, 340, for example) is additionally chosen on the optical disc 300. As with the first sections, only two second sections are shown in this example. However, other embodiments may comprise of additional second sections if desired. Once selected, a second laser write strategy is applied to each of the second sections (330, 340), the second laser write strategy being different from the first laser write strategy. Afterwards, a second feature value is read from each of the second sections to obtain a plurality of second feature values. The sub value can now be calculated according to the first feature values previously determined, and the second feature values. Calibration of laser write strategy of the optical recording device is now performed according to the new sub value, which includes consideration of first and second feature values of the first and second sections.

Applying a second laser write strategy allows for greater tuning precision in controlling the laser power of the optical storage device . In most practical applications, the laser recording power varies during OPC, and as such, information from various levels of applied power would serve useful in determining an optimal power level during recording.

Application of the second laser write strategy can also be devised to occur only if deemed required after performing the first stage of tuning, with the first laser write strategy described above. If only after performing the above method utilizing only the first sections and the first laser write strategies, the sub value is not within a proper predetermined range after, then the second laser write strategy can be additionally used to gather more information in “fine-tuning” calibration of the laser write strategy. A plurality of second sections can then be chosen on the optical disc 300. When selected, a second laser write strategy is applied to each of the second sections, the second laser write strategy being different from the first laser write strategy. Afterwards, a second feature value is read from each of the second sections to obtain a plurality of second feature values. The sub value can now be calculated according to the first feature values previously determined, and the second feature values. Calibration of laser write strategy of the optical recording device is now performed according to the updated sub value, which considers the first and second feature values of the first and second sections.

In applying the second laser write strategy, each second section can be adjacent to a different first section such that they can be applied in sequence (ie. laser applied to first section, then to second section etc.), where a particular second section is recorded after the first laser write strategy has been applied to an adjacent first section of the particular second section. The second laser write strategy can also applied in an indeterminate order different from that above. The sequencing for applying the second laser write strategy to a second section, is therefore not necessarily dependant on the order of application of the first laser write strategy, and can vary in different embodiments of the present invention.

Similar to the first feature values, the second feature values can be a beta value, an RF peak to peak value, a length deviation value, an edge deviation value or a bit error rate value. The sub value therefore can now be determined from a variety of different feature types, specifically, according to the chosen first feature value type and second feature value type.

The first laser write strategy and the second laser write strategy can respectively correspond to different laser recording powers. Also,the first laser write strategy and the second laser write strategy can also respectively correspond to different laser recording pulse shapes. Again, the specific chose of the laser write strategies can be selected according to a desired type by the user.

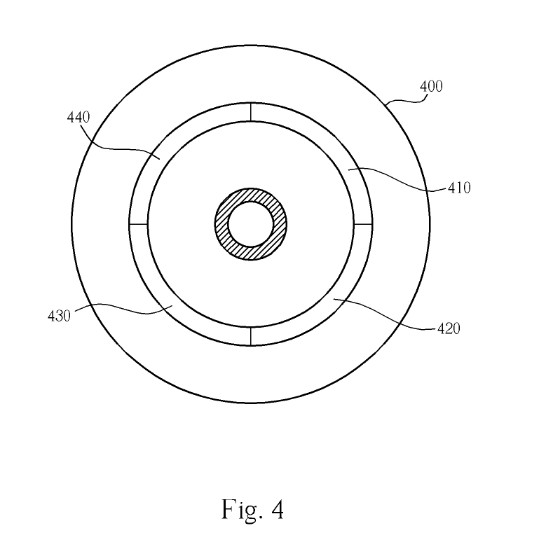

While FIG. 3 illustrates the first (310, 320) and second sections (330, 340) being selected on the optical disc 300 in an arbitrary manner, more systematic approaches can be used where the sections are more uniformly distributed. One embodiment is illustrated in FIG. 4, where the first sections (410, 430 for example) are selected from a ring of the spiral tracks on the optical disc 400. Please note that for easily illustration, FIG. 4 and the following figures show the test recording sections on a concentric ring instead of a spiral track. Additionally, the second sections (420, 440 for example) can also be selected from the same spiral ring. A configuration such as this may provide enhanced calibration results as the sub value can be determined according to a more uniform distribution of first and second sections. As with previous description, the first feature value and the second feature value are each of a type being a beta value, an RF peak to peak value, a length deviation value, an edge deviation value, or a bit error rate value, derived from the first and second feature sections, respectively. The first feature value can also be of a different type than the second feature value, as they do not necessarily need to be the same in this invention. In some embodiments, different feature values can be retrieved from the sections of the optical disc for calibrating the laser write strategy.

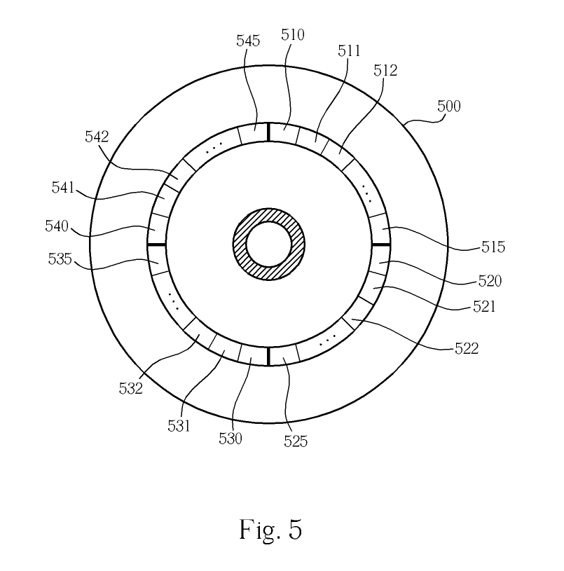

While the previous embodiments only illustrate using one or perhaps two laser write strategies, perhaps more practical applications for OPC calibration may use multiple laser write strategies to determine the characteristics for a full range. Another described method for OPC calibration of the present invention, using a wider range of recording powers is illustrated through FIG. 5. Although this illustration displays sections selected from a spiral ring, please not that it is provided for illustrative purposes, as other embodiments may have sections arbitrarily selected from the optical disc 500 different from the illustration. The selection and arrangement of sections are intermediate, and can occur in a variety of combinations or permutations as long as the principles of the present invention calibration method remain intact.

In this example of the method, an optical disc 500 is provided having a plurality of sections (510-545 for example) selected from them. The various sections are further divided into four quadrants to provide clarity in this example: the first quadrant (510-515), second quadrant (520-525), third quadrant (530-535) and fourth quadrant (540-545). The division of sections into quadrants are not critical to overall operation of the present invention method, but are included to explain the present invention method.

A plurality of laser write strategies are then selected, where each laser write strategies is different from one another. Each unique laser write strategy is then applied to at least two different sections in the plurality of sections. For example, one laser write strategy can be applied to one section in each quadrant (510, 520, 530, 540), while another laser write strategy can be applied to a different section in each quadrant (511, 521, 531, 541), and so forth until all laser write strategies have been applied to different sections. Afterwards, a feature value can be obtained for each section. As with previous examples, the feature value can comprise a beta value, a peak to peak value, a length deviation value, or a bit error rate value. The sub value is subsequently calculated according to the feature values obtained above, and used to optimize calibration of laser write strategy of the optical storage device.

The sub value will thus take into consideration each feature value resulting from each section exposed to a different laser write strategy. Because certain sections are also exposed to the same laser write strategies, the sub value can average or calculate results from these sections to allow for an improved overall calibration of laser power across the entire disc. The sub value can be a statistical average of feature values, or be calculated from a predetermined formula according to a particular calibration strategy of the user.

Also, each of the different laser write strategies can be applied to non-adjacent sections (as in the above example) for systematically varying and distributing the power levels across the optical disc. However, the order of application of different laser recording power levels is intermediate, and can occur in a number of permutations or sequences as long as the teachings of the present invention remain intact.

Consistent with the initially described method, the plurality of sections can be selected from a spiral ring or arbitrarily selected about the optical disc.

Also, the laser write strategies may respectively correspond to different laser recording pulse shapes, or to different laser recording powers.

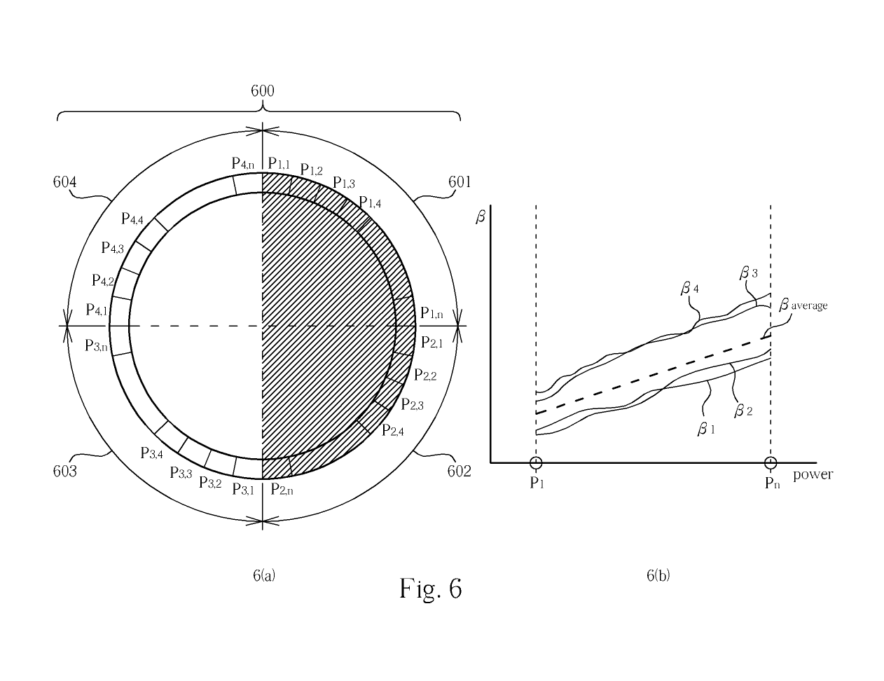

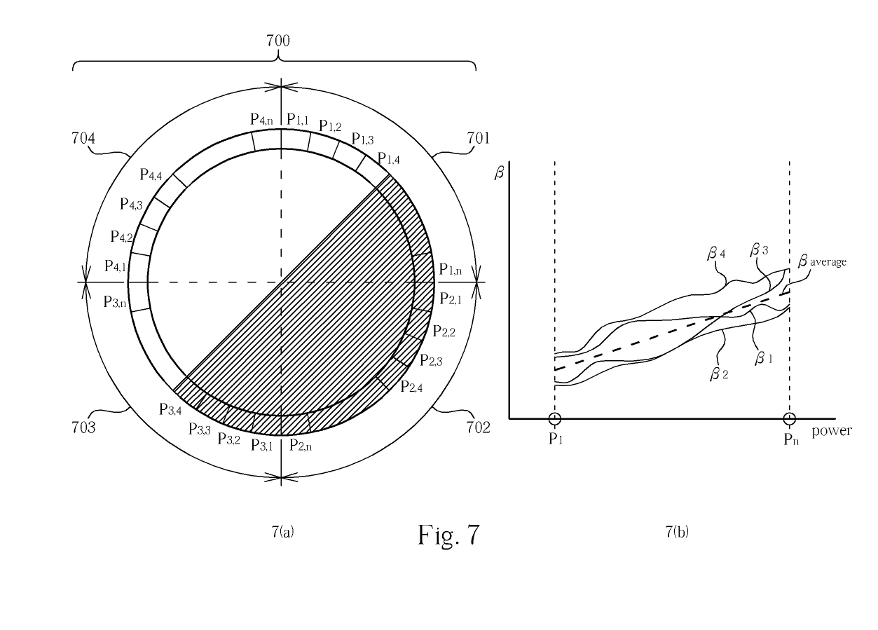

To further aid in the explanation of the above method by way of example, FIG. 6 and FIG. 7 are provided below. FIG. 6(a) shows an example of an optical disc 600 having uneven reflectivity across its surface. Particularly, there is a symmetrical discontinuity in reflectivity across the vertical plane, the right side having a lower reflectivity than the left side. Again in this example, the optical disc 600 is divided into four quadrants for illustrative purposes: the first quadrant 601 and the second quadrant 602 of low reflectivity's, and the third quadrant 603 and fourth quadrant 604 of high reflectivity's.

Continuing with the example, a plurality of sections are selected on the optical disc, illustrated by sections P₁₁, P₁₂, . . . P₁ₙ, of the first quadrant 601, sections P₂₁, P₂₂, . . . P₂ₙ of the second quadrant 602, sections P₃₁, P₃₂, . . . P₃ₙ of the third quadrant 603, and finally sections P₄₁, P₄₂, . . . P₄ₙ of the fourth quadrant 604. A first laser write strategy is then applied to one section of each of the quadrants, say sections P₁₁, P₂₁, P₃₁ and P₄₁. A second laser write strategy is then applied to another section in each of the quadrants, say sections P₁₂, P₂₂, P₃₂ and P₄₂. This is repeated until the last laser write strategy is applied to the last selected section. Upon extracting the feature value from each of the sections, a chart such as that in 6(b) can be obtained.

A plot of the extracted feature values for each quadrant against the specific laser write strategy can be deduced. In FIG. 6(b), for illustrative purposes, the laser write strategy is chosen to be a laser recording power (on the horizontal axis), while the feature value is selected as a beta value (on the vertical axis). Each of the Beta curves for each quadrant is listed as β₁, β₂, β₃, and β₄ respectively. As expected, the general trend shows that the higher laser recording power applied, the higher the resulting Beta value is. Additionally, the quadrants having lower reflectivities (601, 602), also have displaced Beta curves being lower than that for quadrants of high reflectivities (603, 604). The information from these various Beta curves can then be used to form an average value β_{average}, from which the calibration of laser power can now be targeted towards. Calibration using the average value, β_{average}, would therefore provide a more appropriate setting with which a laser power would be more effective across the entire optical disc.

FIG. 7(a) shows another example, where an optical disc 700 has a symmetrical discontinuity in reflectivity across a diagonal plane. As this situation simply represents the previous situation, with a slight rotation in the coordinate system, we should expect similar results. Nonetheless we will continue this example for further clarification. The upper right side in this example, has a lower reflectivity than the lower left side. As the optical disc 700 is again divided into four quadrants similar to above, we see that the first quadrant 701 and the third quadrant 703 enclose the discontinuities, while the second quadrant 702 is purely of low reflectivity, and the fourth quadrant 704 is of purely high reflectivity.

Applying the same steps as in 6(a), a plot for Beta vs. laser recording power is provided in 7(b) for a series of each of the quadrants.

The Beta curves for each quadrant are listed as β₁, β₂, β₃, and β₄ respectively. We see that the curves for β₁, and β₃ contain a crossover from the discontinuities in reflectivity within each quadrant. Additionally, quadrant 4 purely having the higher reflectivity results in β₄ having the generally higher beta values. Quadrant 2, purely having the lower reflectivity results in β₂ having the generally lowest beta values. Although the individual quadrant beta curves are more varied in this example due to the rotational coordinate shift, we note that the average value, β_{average,} is similar to that in 6(b). This should be expected, as they are similar cases, but simply a rotational shift differentiating the two. The example continues to show that localized beta values (such as that confined to a single quadrant) can vary greatly depending on the specific region chosen. However, if many regions are considered, an average beta can be deduced which is appropriate for the entire disc, regardless of the coordinate system used in the process.

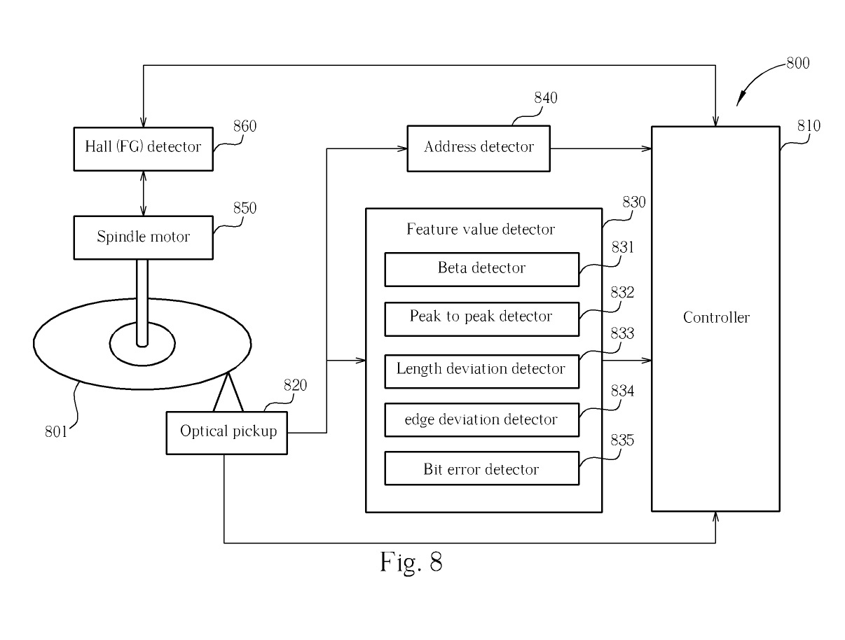

FIG. 8 illustrates an embodiment of an optical storage device 800 for performing Optimum Power Control (OPC) calibration of the present invention. According to FIG. 8, the optical storage device 800 includes: a controller 810 for selecting a plurality of first sections on an optical disc 801, an optical pickup 820 coupled to the controller for applying a first laser write strategy to each of the first sections; and a feature value detector 830 coupled to the optical pickup 820 and the controller 810, for detecting a first feature value read from the optical pickup 820 for each of the first sections to thereby obtain a plurality of first feature values. The controller 810 is further for calculating a sub value according to the first feature values and for calibrating laser power of the optical pickup 820 according to the sub value. The sub value can be calculated according to a statistical average by the controller 810.

The feature value detector further 830 can also include a beta detector 831 for detecting the beta value, an RF peak to peak detector 832 for detecting the RF peak to peak value, a length deviation detector 833 for detecting the length deviation value, an edge deviation detector 834 for detecting the edge deviation value, and a bit error detector 835 for detecting the bit error rate value. Please note that the feature value detector 830 can be realized by any one of the detectors listed above, or by any combination of the detectors. The first feature value detected by the feature value detector can therefore be a beta value, an RF peak to peak value, a length deviation value, an edge deviation value, or a bit error rate value.

Additionally, a spindle motor 850 is used for rotating the optical disc 801, a hall signal detector 860 coupled between the spindle motor 850 and the controller 810, for generating a hall signal indicative of a position of the optical pickup 820 relative to the optical disc 801 so that the controller 810 can further for verifying locations of the first sections according to the hall signal. An address detector 840 coupled between the optical pickup 820 and the controller 810, is also utilized to provide an address signal indicative of a position of the optical pickup relative to the optical disc. Both components (860, 840) thus serve in providing signals for the controller to further verify locations of the first sections. The respective signals can be independently used, or used in conjunction with each other according to the range of precision desired by the user.

In the optical storage device 800 of FIG. 8, the controller can also be used for selecting a plurality of second sections on the optical disc 801. The optical pickup 820 further for applying a second laser write strategy to each of the second sections, while the feature value detector 830 further for detecting a second feature value read from the optical pickup 820 for each of the second sections to thereby obtain a plurality of second feature values. After which, the controller 810 calculates the sub value according to the first feature values and the second feature values.

If the sub value is not within a defined predetermined range, when only considering the first feature values, the optical storage device 800 can then be configured to incorporate the second feature values in determination. In this case, only then does the controller 810 further select a plurality of second sections on the optical disc 801. As with prior description, the optical pickup 820 applies the second laser write strategy to each of the second sections, the feature value detector 830 further for detects a second feature value read from the optical pickup 820 for each of the second sections to thereby obtain a plurality of second feature values, and the controller 810 finally calculates the sub value according to the first feature values and the second feature values.

Each second section selected by the controller 810 can be adjacent to a different first section, where the optical pickup 820 can apply the second laser write strategy to a particular second section after applying the first laser write strategy to a first section being adjacent to the particular second section.

Additionally, the plurality of first and the plurality of second sections selected by the controller 810 can be from a concentric ring centered about the optical disc 801. The first feature value and the second feature value detected by the feature value detector 830 are each of a type being a beta value, an RF peak to peak value, a length deviation value, an edge deviation value, or a bit error rate value. The first feature value can also be of a different type than the second feature value depending on the specific embodiment.

The first laser write strategy applied by the optical pickup can correspond to a laser recording pulse shape, or to a laser recording power. In one embodiment, the first laser write strategy and the second laser write strategy applied by the optical pickup 820 respectively correspond to different laser recording powers. In other embodiments, the first laser write strategy and the second laser write strategy applied by the optical pickup 820 respectively correspond to different laser recording pulse shapes.

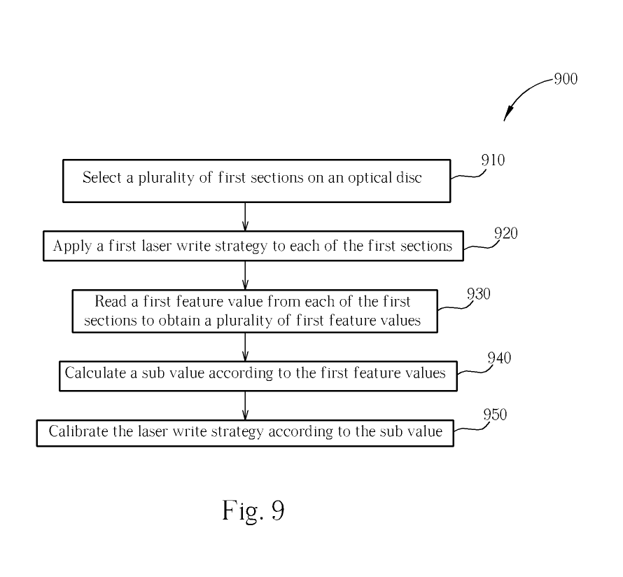

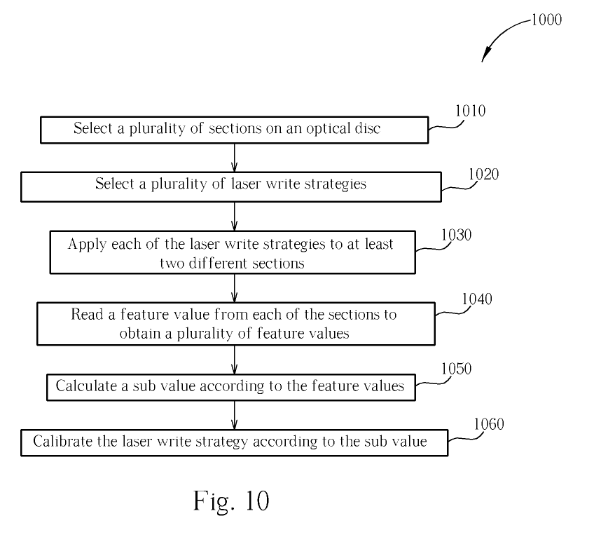

A flow chart illustrating the various OPC calibration methods is shown below in FIG. 9 and FIG. 10. Provided that substantially the same result is achieved, the steps of the process 900 and 1000 need not be in the exact order shown and need not be contiguous, that is, other steps can be intermediate. The calibration method 900 for Optimum Power Control (OPC) of laser power in an optical storage device comprises:

Step 910: Select a plurality of first sections on an optical disc.

Step 920: Apply a first laser write strategy to each of the first sections.

Step 930: Read a first feature value from each of the first sections to thereby obtain a plurality of first feature values.

Step 940: Calculate a sub value according to the first feature values.

Step 950: Calibrate the laser write strategy according to the sub value.

Another calibration method 900 for Optimum Power Control (OPC) of laser power in an optical storage device comprises:

Step 1010: Select a plurality of sections on an optical disc.

Step 1020: Select a plurality of laser write strategies, each laser write strategy being different.

Step 1030: Apply each of the laser write strategies to at least two different sections.

Step 1040: Read a feature value from each of the sections to thereby obtain a plurality of feature values.

Step 1050: Calculate a sub value according to the feature values.

Step 1060: Calibrate the laser write strategy according to the sub value.

This invention therefore solves problems associated with non-uniform reflectivity in optical discs by considering multiple sections of the disc when performing an OPC calibration procedure. Each individual laser write strategy is applied to a plurality of sections. The laser write strategies can correspond to laser recording powers, or to laser recording pulse shapes. Therefore, multiple readings can be attained for each individual laser write strategy applied, allowing for an average reading of the entire disc to compensate for disc irregularities and inconsistencies in reflectivity. In this way, the average reflectivity of the entire disc is considered in order to deduce a more accurate recording power level applicable for the entire disc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A calibration method for Optimum Power Control (OPC) of laser write strategy in an optical storage device, the method comprising:
selecting a plurality of first sections on an optical disc;
applying a first laser write strategy to each of the first sections;
reading a first feature value from each of the first sections to thereby obtain a plurality of first feature values;
calculating a sub value according to the first feature values; and
calibrating the laser write strategy according to the sub value.

2. The calibration method of claim 1 further comprising:
selecting a plurality of second sections on the optical disc;
applying a second laser write strategy to each of the second sections;
reading a second feature value from each of the second sections to thereby obtain a plurality of second feature values; and
calculating the sub value according to the first feature values and the second feature values.

3. The calibration method of claim 1 further comprising when the sub value is not within a predetermined range:
selecting a plurality of second sections on the optical disc;
applying a second laser write strategy to each of the second sections;
reading a second feature value from each of the second sections to thereby obtain a plurality of second feature values; and
calculating the sub value according to the first feature values and the second feature values.

4. The calibration method of claim 3 wherein each second section is adjacent to a first section, and the second laser write strategy is applied to a particular second section after the first laser write strategy has been applied to a first section being adjacent to the particular second section.

5. The calibration method of claim 3, wherein the plurality of first sections and the plurality of second sections are selected from a spiral ring centered about the optical disc.

6. The calibration method of claim 3, wherein the first feature value and the second feature value are each of a type being a beta value, an RF peak to peak value, a length deviation value, an edge deviation value, or a bit error rate value.

7. The calibration method of claim 6, wherein the first feature value is of a different type than the second feature value.

8. The calibration method of claim 3, wherein the first laser write strategy and the second laser write strategy respectively correspond to different laser recording powers or laser recording pulse shapes.

9. The calibration method of claim 1, wherein the first sections are selected from a spiral ring centered about the optical disc.

10. The calibration method of claim 1, wherein the first feature value is a beta value, an RF peak-to-peak value, a length deviation value, an edge deviation value, or a bit error rate value.

11. The calibration method of claim 1, wherein the sub value is a statistical average.

12. The calibration method of claim 1, wherein the first laser write strategy corresponds to a laser recording pulse shape or a laser recording power.

13. The calibration method of claim 1 further comprising verifying locations of the first sections according to a hall signal or an address signal.

14. A calibration method for Optimum Power Control (OPC) of laser write strategy in an optical storage device comprising:
selecting a plurality of sections on an optical disc;
selecting a plurality of laser write strategies, each laser write strategy being different;
applying each of the laser write strategies to at least two different sections;
reading a feature value from each of the sections to thereby obtain a plurality of feature values;
calculating a sub value according to the feature values; and
calibrating the laser write strategy according to the sub value.

15. The calibration method of claim 14 further comprising applying each of the laser write strategies to non-adjacent sections.

16. The calibration method of claim 14, wherein the feature value can comprise a beta value, a peak to peak value, a length deviation value, or a bit error rate value.

17. The calibration method of claim 14, wherein the sections are selected from a sprial ring centered about the optical disc.

18. The calibration method of claim 14, wherein the sub value is a statistical average.

19. The calibration method of claim 14, wherein the laser write strategies respectively correspond to different laser recording pulse shapes or laser recording powers.

20. An optical storage device for performing Optimum Power Control (OPC) calibration comprising:
a controller for selecting a plurality of first sections on an optical disc;
an optical pickup coupled to the controller for applying a first laser write strategy to each of the first sections; and
a feature value detector coupled to the optical pickup and the controller, for detecting a first feature value read from the optical pickup for each of the first sections to thereby obtain a plurality of first feature values;
wherein the controller is further for calculating a sub value according to the first feature values and for calibrating laser write strategy of the optical pickup according to the sub value.

21. The optical storage device of claim 20, wherein the controller is further for selecting a plurality of second sections on the optical disc; the optical pickup is further for applying a second laser write strategy to each of the second sections; the feature value detector is further for detecting a second feature value read from the optical pickup for each of the second sections to thereby obtain a plurality of second feature values; and the controller is additionally for calculating the sub value according to the first feature values and the second feature values.

22. The optical storage device of claim 20, wherein when the sub value is not within a predetermined range, the controller is further for selecting a plurality of second sections on the optical disc; the optical pickup is further for applying a second laser write strategy to each of the second sections; the feature value detector is further for detecting a second feature value read from the optical pickup for each of the second sections to thereby obtain a plurality of second feature values; and the controller is for calculating the sub value according to the first feature values and the second feature values.

23. The optical storage device of claim 22 wherein each second section selected by the controller is adjacent to a different first section, and the optical pickup is further for applying the second laser write strategy to a particular second section after applying the first laser write strategy to a first section being adjacent to the particular second section.

24. The optical storage device of claim 22, wherein the plurality of first and the plurality of second sections selected by the controller are from a sprial ring centered about the optical disc.

25. The optical storage device of claim 22 wherein the first feature value and the second feature value detected by the feature value detector are each of a type being a beta value, an RF peak to peak value, a length deviation value, an edge deviation value, or a bit error rate value.

26. The optical storage device of claim 25, wherein the feature value detector further comprises:
a beta detector for detecting the beta value;
an RF peak to peak detector for detecting the RF peak to peak value;
a length deviation detector for detecting the length deviation value;
an edge deviation detector for detecting the edge deviation value;and
a bit error detector for detecting the bit error rate value.

27. The optical storage device of claim 25, wherein the first feature value is of a different type than the second feature value.

28. The optical storage device of claim 22, wherein the first laser write strategy and the second laser write strategy applied by the optical pickup respectively correspond to different laser recording powers or laser recording pulse shapes.

29. The optical storage device of claim 20, wherein the plurality of first sections selected by the controller are from a sprial ring centered about the optical disc.

30. The optical storage device of claim 20 wherein the first feature value detected by the feature value detector is a beta value, an RF peak to peak value, a length deviation value, an edge deviation value, or a bit error rate value.

31. The optical storage device of claim 30 wherein the feature value detector further comprises:
a beta detector for detecting the beta value;
an RF peak to peak detector for detecting the RF peak to peak value;
a length deviation detector for detecting the length deviation value;
an edge deviation detector for detecting the edge deviation value; and
a bit error detector for detecting the bit error rate value.

32. The optical storage device of claim 20, wherein the controller is further for calculating the sub value according to a statistical average.

33. The optical storage device of claim 20, wherein the first laser write strategy applied by the optical pickup corresponds to a laser recording pulse shape or a laser recording power.

34. The optical storage device of claim 20 further comprising: a spindle motor for rotating the optical disc; and
a hall signal detector coupled between the spindle motor and the controller, for generating a hall signal indicative of a position of the optical pickup relative to the optical disc;
wherein the controller is further for verifying locations of the first sections according to the hall signal.

35. The optical storage device of claim 20 further comprising:
an address detector coupled between the optical pickup and the controller, for providing an address signal indicative of a position of the optical pickup relative to the optical disc;
wherein the controller is further for verifying locations of the first sections according to the address signal.
